(19) United States
(12) Patent Application Publication
(10) Pub. No.: US 2026/0163916 A1
(43) Pub. Date: Jun. 11, 2026

(54) PLACEMENT LOCATION SELECTION DEVICE, PLACEMENT LOCATION SELECTION METHOD, AND NON-TRANSITORY COMPUTER READABLE MEDIUM

(71) Applicant: Mitsubishi Electric Corporation, Tokyo (JP)

(72) Inventors: Takumi YAMAMOTO, Tokyo (JP); Aiko IWASAKI, Tokyo (JP)

(73) Assignee: Mitsubishi Electric Corporation, Tokyo (JP)

(21) Appl. No.: 19/179,718

(22) Filed: Apr. 15, 2025

Related U.S. Application Data
(63) Continuation of application No. PCT/JP2022/044978, filed on Dec. 6, 2022.

(51) Int. Cl. H04L 9/40

(52) U.S. Cl. CPC H04L 63/1491; H04L 63/1433

(57) ABSTRACT

A placement location selection device (100) includes a decoy placement unit (140) that places a decoy file in an area corresponding to part of a file tree and excluding a first non-target area and a second non-target area in a target system. The first non-target area is an area estimated to be used by a high-risk user in normal work of the high-risk user. The second non-target area is an area estimated to be used by each user other than the high-risk user in normal work of each user.

### CROSS REFERENCE TO RELATED APPLICATION

This application is a Continuation of PCT International Application No. PCT/JP2022/044978, filed on Dec. 6, 2022, which is hereby expressly incorporated by reference into the present application.

### TECHNICAL FIELD

The present disclosure relates to a placement location selection device, a placement location selection method, and a placement location selection program.

### BACKGROUND ART

As a countermeasure against security attacks, there is a deception system that uses decoy data. Patent Literature 1 discloses a technology that intercepts a data read from a process determined to be fraudulent and returns false data to the process.

### CITATION LIST

### Patent Literature

Patent Literature 1: U.S. Pat. No. 9,773,109 B2

### SUMMARY OF INVENTION

### Technical Problem

The technology disclosed in Patent Literature 1 may return false data to a legitimate process because the accuracy of fraud assessment is not necessarily perfect. If false data is returned to a legitimate process, the work of a legitimate user without malicious intent will be hindered. Therefore, a problem of this technology is that there is a risk of interfering with the work of a legitimate user without malicious intent.

An object of the present disclosure is to reduce a risk of interfering with the work of a legitimate user without malicious intent in a deception system that uses decoy data.

### Solution to Problem

A placement location selection device according to the present disclosure includes
a decoy placement unit to place one or more decoy files in a placement target area corresponding to part of a file tree and excluding a first non-target area and a second non-target area,
the first non-target area being an area corresponding to part of the file tree managed by a target system and including one or more files estimated to be used by a high-risk user who is a user of the target system in normal work of the high-risk user among files included in a target file group composed of files accessed by the high-risk user and indicated by an access log in the target system,
the second non-target area being an area corresponding to part of the file tree and including one or more files estimated to be accessed by each user included in a target normal user group in normal work of each user, the target normal user group being composed of one or more users, other than the high-risk user, of the target system who have accessed at least one file that is present outside the first non-target area among the files included in the target file group.

### Advantageous Effects of Invention

According to the present disclosure, a decoy file is placed in an area excluding a first non-target area and a second non-target area. The first non-target area is an area including one or more files estimated to be used by a high-risk user in normal work of the high-risk user, and the second non-target area is an area including one or more files estimated to be accessed by each user other than the high-risk user in normal work of each user. Therefore, according to the present disclosure, it is possible to reduce a risk of interfering with the work of a legitimate user without malicious intent in a deception system that uses decoy data.

### BRIEF DESCRIPTION OF DRAWINGS

FIG. 1 is a figure illustrating a configuration example of a placement location selection device 100 according to Embodiment 1;

FIG. 2 is a figure describing processing by a normal work analysis unit 130 and a decoy placement unit 140 according to Embodiment 1;

FIG. 3 is a figure illustrating an implementation example of a placement location selection system 90 according to Embodiment 1;

FIG. 4 is a figure illustrating a hardware configuration example of the placement location selection device 100 according to Embodiment 1;

FIG. 5 is a flowchart illustrating the operation of the placement location selection device 100 according to Embodiment 1;

FIG. 6 is a figure illustrating a hardware configuration example of the placement location selection device 100 according to a variation of Embodiment 1;

FIG. 7 is a figure illustrating a configuration example of the placement location selection device 100 according to Embodiment 2;

FIG. 8 is a figure describing placement of decoy files 191 according to Embodiment 2;

FIG. 9 is a figure describing access patterns 281 and placement rules 291 according to Embodiment 2;

FIG. 10 is a figure describing access patterns 281 and placement rules 291 according to Embodiment 2; and

FIG. 11 is a flowchart illustrating the operation of the placement location selection device 100 according to Embodiment 2.

### DESCRIPTION OF EMBODIMENTS

In the description and drawings of embodiments, the same reference numerals are assigned to the same elements and corresponding elements. The description of elements with the same reference numerals is omitted or simplified as appropriate. Arrows in figures mainly indicate flows of data or flows of processing. “Unit” may be read as “circuit,” “step”, “procedure”, “process”, or “circuitry” as appropriate.

### Embodiment 1

This embodiment will be described in detail below with reference to the drawings.

### Description of Configuration

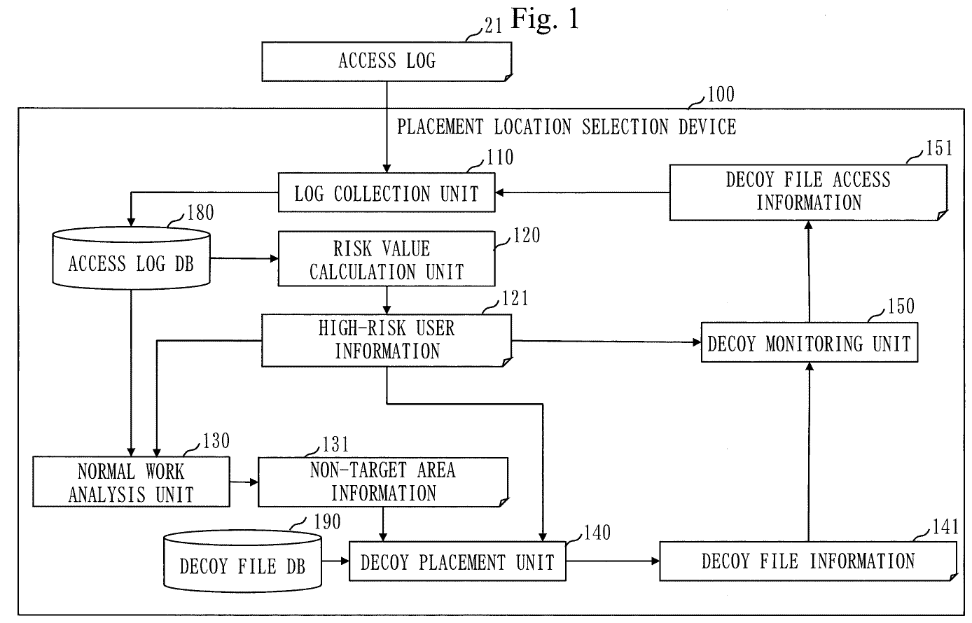

FIG. 1 illustrates a configuration example of a placement location selection device 100 according to this embodiment. As indicated in this figure, the placement location selection device 100 includes a log collection unit 110, a risk value calculation unit 120, a normal work analysis unit 130, a decoy placement unit 140, and a decoy monitoring unit 150. The placement location selection device 100 stores an access log database (DB) 180 and a decoy file DB 190.

The log collection unit 110 collects an access log 21 and an access log for a decoy file 191, and records the collected logs in the access log DB 180. The access log 21 is a file access log in a target system 20.

The target system 20 is a computer system that is used by a plurality of users in work and stores a plurality of files. As a specific example, the target system 20 is a system operated based on zero trust, and is composed of at least one of an on-premises system and a cloud system. The target system 20 manages each file of the plurality of files as part of a file tree. The file tree is a file system that manages the plurality of files hierarchically. In the target system 20, each file is stored in a folder, and each user uses a file access tool to access each file managed by the target system 20. A folder is also called a directory. The file access tool is a tool for each user to access each file, and is an explorer or a browser, as a specific example.

The risk value calculation unit 120 calculates a risk value corresponding to each user based on a file access log or the like in the target system 20. When the decoy file 191 is not placed, the risk value calculation unit 120 typically calculates a risk value corresponding to each user based on an access pattern of each user in the target system 20. Also when the decoy file 191 is placed, the risk value calculation unit 120 may calculate a risk value corresponding to each user based on the access pattern of each user in the target system 20. When the decoy file 191 is placed in the target system 20, the risk value calculation unit 120 may use an access log for the decoy file 191 when calculating a risk value corresponding to each user. The risk value calculation unit 120 may raise a risk value corresponding to a target user when the target user has accessed at least one of one or more decoy files 191. Each user is a user of the target system 20. Each user may be a human or a computer.

The risk value corresponding to each user is a value that is calculated based on the behavior of each user in the target system 20 and corresponds to a possibility that each user is actually a malicious insider. The behavior of each user in the target system 20 is the conduct of each user in the target system 20. Components of the behavior of each user are, as a specific example, files accessed by each user, an order in which each user has accessed the files, a time period during which each user has accessed the files, and the number of files accessed by each user per unit time. A malicious insider is an entity that operates within an organization with the intent to steal data from the organization. A malicious insider is, as a specific example, an internal attacker in the target system 20, or malware that has stolen legitimate credentials and infected a personal computer (PC) used in the organization that manages the target system 20. An internal attacker is a user who engages in a security attack among users with legitimate access privileges. An internal attacker is also a user with malicious intent. As a specific example, malware is one that operates autonomously on its own, or one that operates in accordance with commands from an attacker outside the organization via a command and control server on the Internet.

The risk value calculation unit 120 may model a pattern of normal behavior in the target system 20 for each user based on the file access log or the like in advance, and calculate a degree of deviation of the actual behavior of each user in the target system 20 from the modeled pattern of normal behavior as the risk value corresponding to each user. When modelling the pattern of normal behavior, the risk value calculation unit 120 may use technologies such as machine learning, or use technologies that detect anomalies in behavior for each user based on an access log, such as user and entity behavior analytics (UEBA).

Additionally, the risk value calculation unit 120 generates high-risk user information 121, and outputs the generated high-risk user information 121. The high-risk user information 121 is information indicating each high-risk user and the characteristics of each high-risk user. As a specific example, the high-risk user information 121 includes data indicating each high-risk user, a risk value corresponding to each high-risk user, and one or more files accessed by each high-risk user. A high-risk user is a user of the target system 20 whose corresponding risk value is equal to or greater than a risk reference value, which is a predefined threshold, and whose possibility of being a malicious insider is relatively high among users of the target system 20. When at least one of the access log 21 and decoy file access information 151 has been updated, the high-risk user information 121 may be updated based on the updated information.

The normal work analysis unit 130 estimates a first non-target area and a second non-target area based on the access log 21. The first non-target area is an area corresponding to part of the file tree managed by the target system 20 and including one or more files estimated to be used by a high-risk user in the normal work of the high-risk user among files included in a target file group. The normal work may be defined in any way. The target file group is composed of files accessed by the high-risk user and indicated by the access log 21. The second non-target area is composed of an area corresponding to part of the file tree and including one or more files estimated to be accessed by each user included in a target normal user group in the normal work of each user. When the target normal user group includes a plurality of users, the second non-target area is the union of normal access areas individually corresponding to these users. The target normal user group is composed of one or more users of the target system 20 who are not high-risk users and have accessed at least one file that is present outside the first non-target area among the files included in the target file group. In addition, the normal work analysis unit 130 generates non-target area information 131, and outputs the generated non-target area information 131. The non-target area information 131 is information indicating the areas in each of which the decoy file 191 is not to be placed.

As a specific example, the normal work analysis unit 130 identifies a normal access area corresponding to each high-risk user from a file access log of each high-risk user indicated by the high-risk user information 121, and adds the identified normal access area to a placement non-target area. The normal access area corresponding to each user is a range, in the file tree, normally accessed by each user in work and an area accessed by each user relatively frequently, and as a specific example, is composed of one or more files and one or more directories normally accessed by each user. In this case, as a specific example, the normal work analysis unit 130 treats a file and a directory accessed by each user a predetermined number of times or more within a predetermined period of time as a file and a directory normally accessed by each user. The placement non-target area is an area which corresponds to part of the file tree and in which the decoy file 191 is not to be placed.

In addition, from a log indicating accesses to each file accessed by each high-risk user indicated by the high-risk user information 121, the normal work analysis unit 130 identifies one or more files and one or more directories that other users who usually access each file access with the same or relatively close timing as that of each high-risk user, and adds a range including the identified one or more files and one or more directories to the placement non-target area. In this case, as a specific example, the normal work analysis unit 130 sets each file and each directory that have been accessed a predetermined number of times or more within a predetermined period of time from the timing of access to each file accessed by each high-risk user as the file and directory accessed by other users with the same or close timing as that of each high-risk user.

The decoy placement unit 140 places one or more decoy files 191 in a placement target area. Placing the decoy file 191 includes instructing a plug-in or the like to place the decoy file 191. The placement target area is an area corresponding to part of the file tree managed by the target system 20 and excluding the first non-target area and the second non-target area. The placement target area may include an area expected to be accessed by a high-risk user.

Specifically, the decoy placement unit 140 selects one or more decoy files 191 from the decoy file DB 190, executes an instruction to the target system 20 to place each selected decoy file 191 in an area that is in the file tree, close to a file accessed by each high-risk user indicated by the high-risk user information 121, and outside the placement non-target area, generates decoy file information 141 corresponding to the executed instruction, and outputs the generated decoy file information 141. The decoy file information 141 corresponding to the decoy file 191 is information indicating a file name, a placement location, and so on of the decoy file 191. At this time, the decoy placement unit 140 may randomly select a decoy file 191 from the decoy file DB 190, or select a decoy file 191 from the decoy file DB 190 according to the characteristics of each high-risk user. The decoy placement unit 140 may place the decoy file 191 in the target system 20 instead of executing the instruction to the target system 20 to place the decoy file 191.

The decoy placement unit 140 may extract a topic from the content, file name, and so on of a file accessed by each high-risk user, further perform narrowing down to an area where a file or directory related to the extracted topic is present, and place the decoy file 191 in the narrowed down area. In this case, the decoy placement unit 140 may extract a topic using a topic model such as Top2Vec.

The decoy placement unit 140 may execute an instruction to the target system 20 to create a decoy folder and place the decoy file 191 in the created decoy folder. The decoy placement unit 140 may add information indicating an access made to the decoy file 191 to the access log 21 corresponding to each user.

In the present disclosure, the decoy file 191 is placed on the assumption that a difference in access tendency occurs depending on whether or not each user has malicious intent. A specific example of the difference in access tendency is that a malicious insider accesses not only a work file group corresponding to the malicious insider but also various files not related to the work file group, while a legitimate user without malicious intent (hereinafter referred to as “normal user”) basically accesses only a work file group corresponding to the normal user and a peripheral file group corresponding to the work file group. A legitimate user is a user who is officially registered in the target system 20. A legitimate user may be referred to as “user”. The work file group corresponding to each user is composed of at least one file related to the work of each user. The peripheral file group corresponding to the work file group is composed of at least one file that is other than each file constituting the work file group and that can be reached in a relatively small number of steps from each file constituting the work file group in the file tree.

The decoy file 191 is a file not directly related to the work of each user. The file name, file format, and so on of the decoy file 191 may be generated based on a result of analysis of access tendencies of malicious insiders, for example, so as to attract the interest of malicious insiders, or may be generated by artificial intelligence (AI).

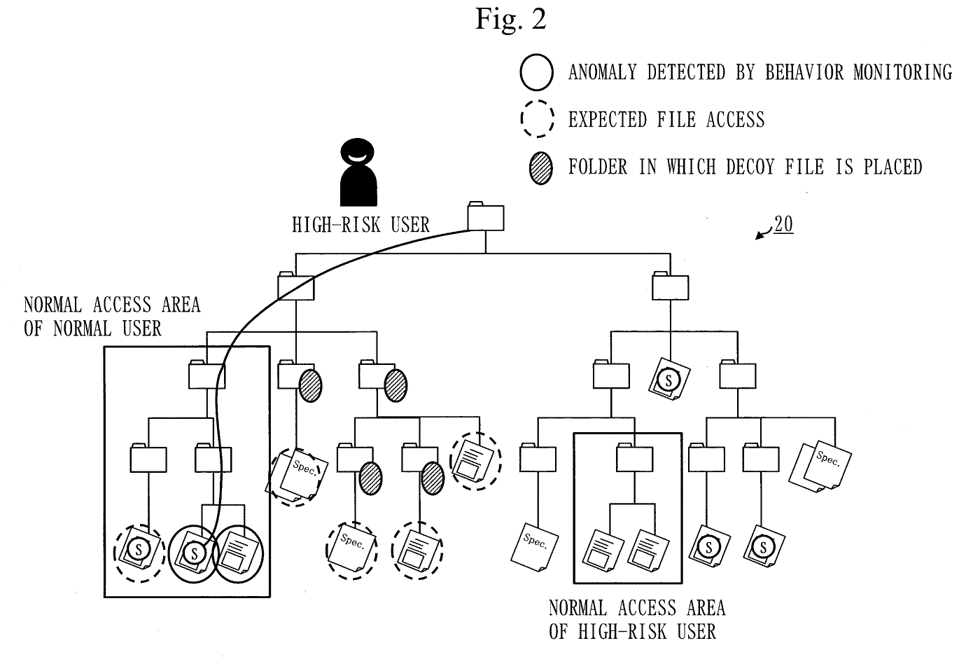

FIG. 2 is a figure describing processing by the normal work analysis unit 130 and the decoy placement unit 140. In FIG. 2, a circled S indicates confidentiality. Using FIG. 2, the processing by the normal work analysis unit 130 and the decoy placement unit 140 will be described.

The normal work analysis unit 130 analyzes file access tendencies of normal users, and estimates folders that each user may access without malicious intent based on the result of analysis. Specifically, the normal work analysis unit 130 estimates a normal access area of normal users and a normal access area of high-risk users. The normal access area of normal users corresponds to the second non-target area. The normal access area of high-risk users corresponds to the first non-target area.

The decoy placement unit 140 selects each folder in which the decoy file 191 is to be placed based on the result of estimation by the normal work analysis unit 130. At this time, the decoy placement unit 140 may predict future file accesses by a high-risk user based on anomalies detected by monitoring the behavior of each user, and place the decoy file 191 in each folder corresponding to each predicted file access. As a specific example, as indicated in FIG. 2, the decoy placement unit 140 predicts future file accesses by the high-risk user, and selects each folder in which the decoy file 191 is to be placed based on the result of prediction.

The decoy monitoring unit 150 monitors accesses to the decoy file 191 indicated by the decoy file information 141 for each high-risk user indicated by the high-risk user information 121, generates decoy file access information 151 corresponding to the result of monitoring, and outputs the generated decoy file access information 151. As a specific example, when there is a high-risk user who has accessed the decoy file 191 a predetermined number of times or more, the decoy file access information 151 is information indicating that the high-risk user has accessed the decoy file 191 the predetermined number of times or more. The high-risk user information 121 may be information indicating that a user other than a high-risk user has accessed the decoy file 191.

An analyst may narrow down high-risk users based on the decoy file access information 151 and the high-risk user information 121, and may reflect the result of narrowing down in the high-risk user information 121. The analyst is, as a specific example, a person or computer that analyzes security attacks on the target system 20.

The access log DB 180 is a database to store information indicating access logs in the target system 20.

The decoy file DB 190 is a database to store one or more decoy files 191.

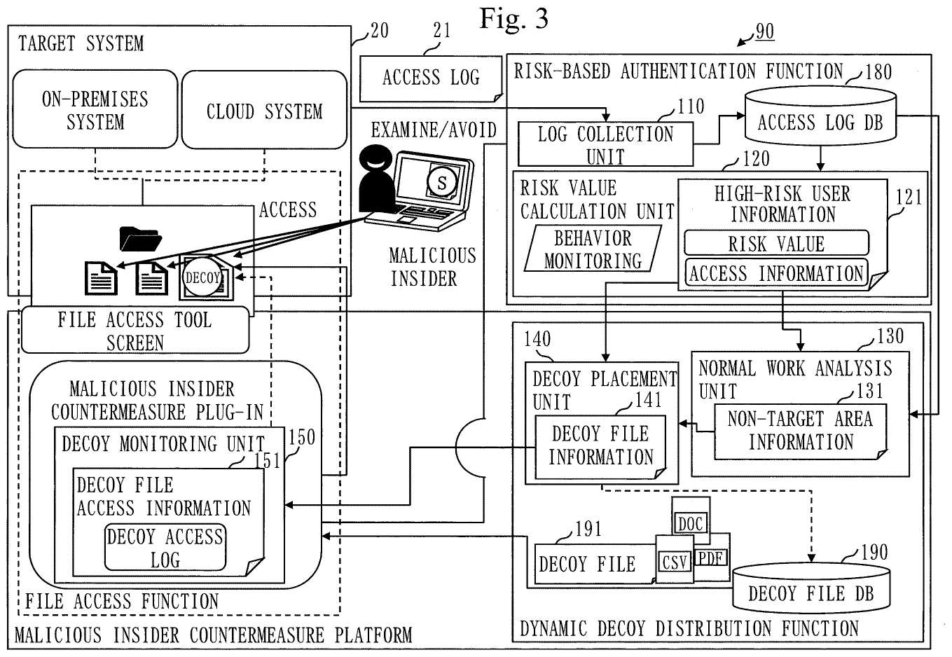

FIG. 3 illustrates an implementation example of a placement location selection system 90 according to this embodiment. Using FIG. 3, the implementation example of the placement location selection system 90 will be described. In FIG. 3, the placement location selection device 100 is illustrated divided by function. It is assumed here that a malicious insider examines files in the target system 20 and evades the decoy file 191.

A risk-based authentication function utilizes a risk-based authentication technology to receive the access log 21 of each user from the target system 20, and calculate a risk value corresponding to each user based on the received log. When the decoy file 191 has already been placed, the risk value calculation unit 120 refers to the access log for the decoy file 191 when calculating the risk value of each user.

A malicious insider countermeasure platform is a system with malicious insider countermeasure functions, and includes a dynamic decoy distribution function and a file access function.

The dynamic decoy distribution function is a function to select a folder in which the decoy file 191 is to be placed, select the decoy file 191, and place the selected decoy file 191 in the selected folder.

The decoy placement unit 140 instructs a malicious insider countermeasure plug-in to place the decoy file 191.

The malicious insider countermeasure plug-in is a software module that adds additional functions to the file access tool. The functions of the decoy monitoring unit 150 are realized by the malicious insider countermeasure plug-in.

The file access tool, which realizes the file access function, places the decoy file 191 using the malicious insider countermeasure plug-in based on an instruction from the dynamic decoy distribution function. The malicious insider countermeasure plug-in may actually place the decoy file 191 in the target system 20, or may display the decoy file 191 on an operation screen of the file access tool when each user has accessed the folder in which the decoy file 191 is to be placed, instead of actually placing the decoy file 191 in the target system 20.

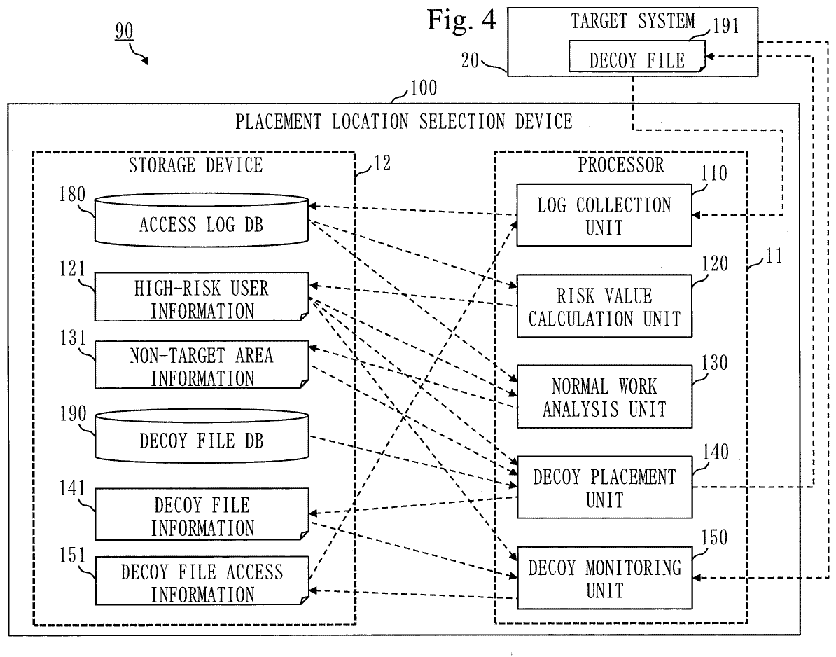

FIG. 4 illustrates a hardware configuration example of the placement location selection device 100 according to this embodiment. The placement location selection device 100 is composed of a general computer. The placement location selection device 100 may be composed of a plurality of computers. The target system 20 and the placement location selection device 100 may be configured integrally.

As illustrated in this figure, the placement location selection device 100 is a computer that includes hardware components such as a processor 11 and a storage device 12. These hardware components are connected as appropriate through signal lines.

The processor 11 is an integrated circuit (IC) that performs operational processing, and controls the hardware included in the computer. The processor 11 is, as a specific example, a central processing unit (CPU), a digital signal processor (DSP), or a graphics processing unit (GPU).

The placement location selection device 100 may include a plurality of processors as an alternative to the processor 11. The plurality of processors share the role of the processor 11.

The storage device 12 is composed of at least one of a volatile storage device and a non-volatile storage device. The volatile storage device is, as a specific example, a random access memory (RAM). The non-volatile storage device is, as a specific example, a read only memory (ROM), a hard disk drive (HDD), or a flash memory. Data stored in the storage device 12 is loaded into the processor 11 as necessary.

The placement location selection device 100 may include hardware such as an input/output interface (IF) and a communication device.

The input/output IF is a port to which an input device and an output device are connected. The input/output IF is, as a specific example, a Universal Serial Bus (USB) terminal. The input device is, as a specific example, a keyboard and a mouse. The output device is, as a specific example, a display.

The communication device is a receiver and a transmitter. The communication device is, as a specific example, a communication chip or a network interface card (NIC).

Each unit of the placement location selection device 100 may use the input/output IF and the communication device as appropriate when communicating with other devices and so on.

The storage device 12 stores a placement location selection program. The placement location selection program is a program that causes a computer to realize the functions of each unit included in the placement location selection device 100. The placement location selection program is loaded into the storage device 12 and executed by the processor 11. The functions of each unit included in the placement location selection device 100 are realized by software.

The storage device 12 may store files that are managed by the target system 20.

Data used when the placement location selection program is executed, data obtained by executing the placement location selection program, and so on are appropriately stored in the storage device 12. Each unit of the placement location selection device 100 uses the storage device 12 as appropriate. The term data and the term information may have substantially the same meaning.

The storage device 12 may be independent of the computer. Each database may be stored in an external server or the like.

The placement location selection program may be recorded in a computer readable non-volatile recording medium. The non-volatile recording medium is, as a specific example, an optical disc or a flash memory. The placement location selection program may be provided as a program product.

### Description of Operation

A procedure for the operation of the placement location selection device 100 is equivalent to a placement location selection method. A program that realizes the operation of the placement location selection device 100 is equivalent to the placement location selection program.

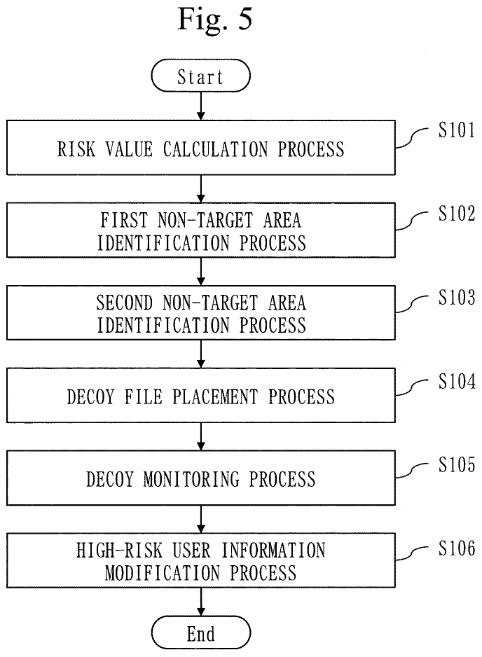

FIG. 5 is a flowchart illustrating an example of the operation of the placement location selection device 100. Referring to FIG. 5, the operation of the placement location selection device 100 will be described.

### (Step S101: Risk Value Calculation Process)

The risk value calculation unit 120 refers to the access log DB 180, and calculates a risk value regarding the behavior of each user based on a file access log.

### (Step S102: First Non-Target Area Identification Process)

The normal work analysis unit 130 identifies, as the first non-target area, an area corresponding to part of the file tree and including a folder group accessed by a high-risk user relatively frequently in usual normal work.

### (Step S103: Second Non-Target Area Identification Process)

The normal work analysis unit 130 identifies, as the second non-target area, an area corresponding to part of the file tree and including a folder accessed relatively frequently in normal work by a user who has accessed a folder not used by the high-risk user in usual normal work among the folder group accessed by the high-risk user.

### (Step S104: DECOY FILE PLACEMENT PROCESS)

The decoy placement unit 140 selects a decoy file 191 from the decoy file DB 190, and places the decoy file 191 at a location avoiding the first non-target area and the second non-target area identified by the normal work analysis unit 130.

### (Step S105: Decoy Monitoring Process)

The decoy monitoring unit 150 monitors accesses to the decoy file 191, generates decoy file access information 151 indicating the result of monitoring, and outputs the decoy file access information 151 that has been generated.

### (Step S106: High-Risk User Information Modification Process)

The risk value calculation unit 120 modifies the high-risk user information 121 based on the decoy file access information 151 that has been output.

### Description of Effects of Embodiment 1

As described above, according to this embodiment, the decoy file 191 is placed avoiding folders usually accessed by legitimate users in a deception system that uses decoy data, so that opportunities for the legitimate users to access the decoy file 191 can be reduced. Therefore, according to this embodiment, the risk of interfering with the work of a legitimate user without malicious intent can be reduced.

According to this embodiment, the decoy file 191 is placed avoiding the first non-target area, so that the risk of interfering with the normal work of a high-risk user can be reduced also in a case where the high-risk user is actually a normal user.

### Other Configurations

### <Variation 1>

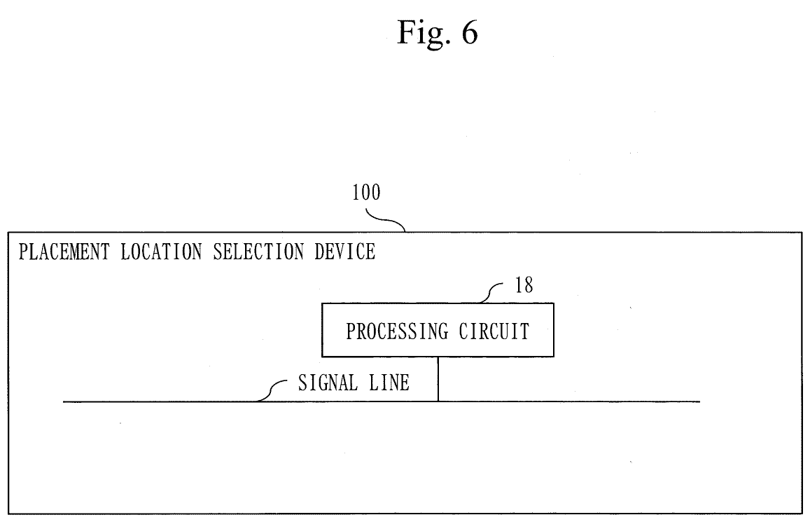

FIG. 6 illustrates a hardware configuration example of the placement location selection device 100 according to this variation.

The placement location selection device 100 includes a processing circuit 18 in place of the processor 11 or in place of the processor 11 and the storage device 12.

The processing circuit 18 is hardware that realizes at least part of the units included in the placement location selection device 100.

The processing circuit 18 may be dedicated hardware, or may be a processor that executes programs stored in the storage device 12.

When the processing circuit 18 is dedicated hardware, the processing circuit 18 is, as a specific example, a single circuit, a composite circuit, a programmed processor, a parallel-programmed processor, an application specific integrated circuit (ASIC), a field programmable gate array (FPGA), or a combination of these.

The placement location selection device 100 may include a plurality of processing circuits as an alternative to the processing circuit 18. The plurality of processing circuits share the role of the processing circuit 18.

In the placement location selection device 100, some functions may be realized by dedicated hardware, and the remaining functions may be realized by software or firmware.

As a specific example, the processing circuit 18 is realized by hardware, software, firmware, or a combination of these.

The processor 11, the storage device 12, and the processing circuit 18 are collectively called “processing circuitry”. That is, the functions of the functional constituent elements of the placement location selection device 100 are realized by the processing circuitry.

The placement location selection device 100 according to other embodiments may be configured in substantially the same way as this variation.

### Embodiment 2

Differences from the embodiment described above will be mainly described below with reference to the drawings.

### Description of Configuration

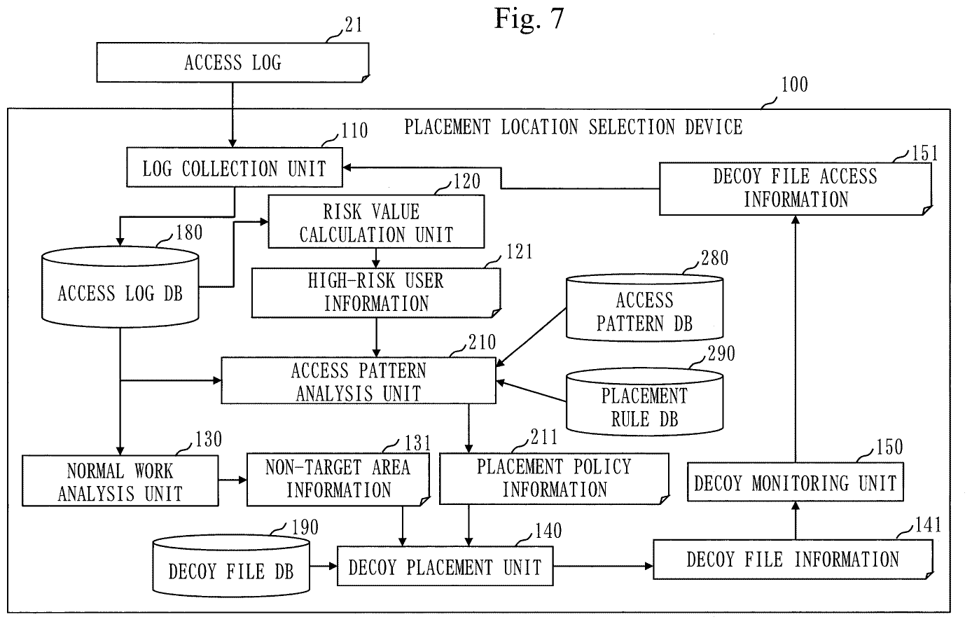

FIG. 7 illustrates a configuration example of the placement location selection device 100 according to this embodiment. As indicated in FIG. 7, the placement location selection device 100 further includes an access pattern analysis unit 210. The placement location selection device 100 further stores an access pattern DB 280 and a placement rule DB 290.

When a malicious insider is trying to collect files to steal in bulk using an automated program such as a script, rather than opening files one by one and visually checking and collecting files to steal, it may be too late to place the decoy file 191 near the file being accessed by the malicious insider at the time point when the risk value corresponding to the malicious insider becomes high, because the area around this file has already been accessed by the time point when the decoy file 191 is placed. Placing the decoy file 191 near this file increases the possibility that a legitimate user without malicious intent will access the decoy file 191.

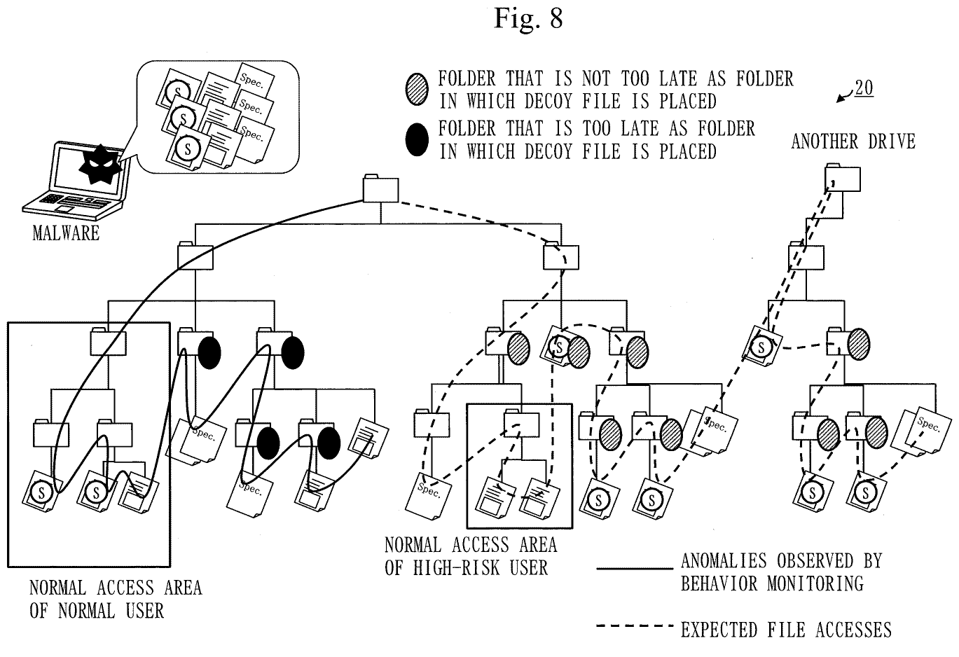

FIG. 8 is a figure describing placement of the decoy files 191 when file accesses by malware have been detected as anomalies. As indicated in FIG. 8, it is too late to place the decoy files 191 near the files being accessed by the malware, but it is not too late to place the decoy files 191 at locations other than near these files.

If the decoy files 191 are placed over a wide range in advance, the possibility that legitimate users without malicious intent will access the decoy files 191 increases.

The appropriate locations for placing the decoy files 191 are considered to vary depending on the access pattern of a malicious insider. Specific examples of the access pattern of a malicious insider are a pattern in which the malicious insider makes accesses manually and a pattern in which the malicious insider makes accesses automatically using malware. Therefore, this embodiment proposes a method for effectively placing the decoy files 191 depending on the type of access pattern.

The access pattern analysis unit 210 analyzes the access pattern in the target system 20 of each user of the target system 20 based on the access log 21. Specifically, the access pattern analysis unit 210 identifies an access pattern 281 corresponding to each high-risk user by checking recent file access log or the like of each high-risk user indicated by the high-risk user information 121 against each access pattern 281 stored in the access pattern DB 280.

Then, the access pattern analysis unit 210 identifies a placement rule 291 corresponding to the identified access pattern 281 from the placement rule DB 290, generates placement policy information 211 based on the result of identification, and outputs the generated placement policy information 211. It is assumed here that the placement rule 291 that is appropriate is defined in advance for each access pattern 281 stored in the access pattern DB 280. There may be an access pattern 281 that cannot be detected by the access pattern analysis unit 210.

The placement policy information 211 is information indicating a policy for placing each decoy file 191.

The access pattern DB 280 stores data indicating each of one or more access patterns 281.

Each access pattern 281 may be, as a specific example, a classification according to at least one of the type of the user, the area where the user has accessed files, and the frequency with which the user has accessed files. Specific examples of the type of the user are an external attacker, a high-risk user, and a low-risk user. A low-risk user is a user who is not a high-risk user. An external attacker may be treated as part of high-risk users.

Each access pattern 281 is equivalent to a file access classification according to expected file access characteristics. Each access pattern 281 may include data related to a detection rule for determining whether or not each access pattern 281 is applicable. As a specific example, the data related to the detection rule indicates at least one of a reference value for the number of files accessed by the user in a certain period of time and a reference value for the number of directories accessed by the user in a certain period of time.

Each access pattern 281 may be a pattern obtained by collecting, in advance, a file access log when file accesses of a malicious insider are manually simulated, a file access log when an automated program such as malware is executed, or the like, and learning the collected log using machine learning or other technologies.

The placement rule DB 290 stores data indicating each of one or more placement rules 291.

The placement rule 291 is a rule indicating an area where each decoy file 191 is to be placed, and a specific example is a rule indicating that the decoy file 191 is to be placed in an area within a range of x or more hops and less than y hops from the placement non-target area. A hop is a unit that represents the distance between two directories, and the distance between two directories that are one layer apart is one hop. Each of x and y is a natural number, and the value of y is greater than the value of x. The placement rule 291 corresponding to an access pattern corresponding to a case where a high-risk user uses malware may be a rule that one or more decoy files 191 are to be placed in an area at least a reference distance away in the file tree from a file accessed by the high-risk user within a past reference time period from the time point of the placement of the one or more decoy files 191. Within the past reference time period from the time point of the placement of the one or more decoy files 191 is a period from a time point that is earlier by the past reference time period from the time point of the placement of the one or more decoy files 191 to the time point of the placement of the one or more decoy files 191.

The placement rule 291 may be a rule that indicates, as a placement target of the decoy file 191, a drive different from a drive accessed by each high-risk user. The placement target may be a file system on a cloud system, or may be a network drive.

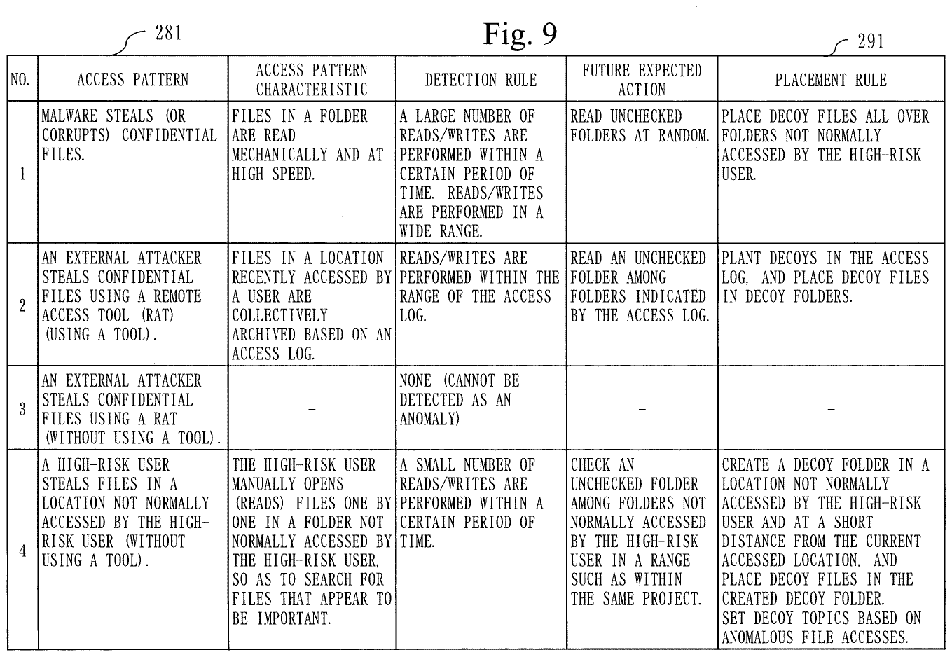

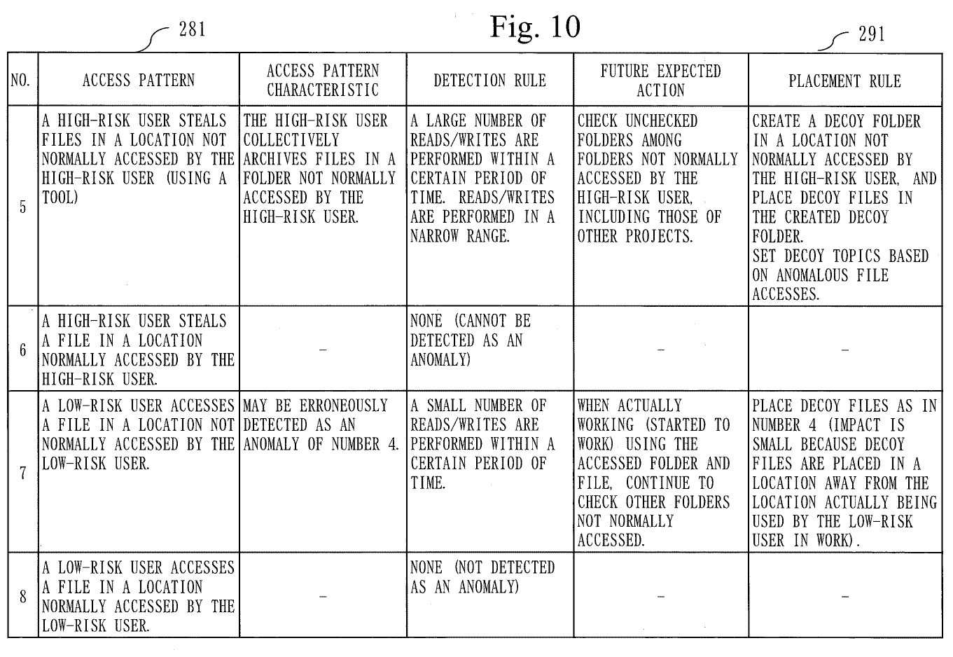

FIGS. 9 and 10 are figures describing a specific example of each access pattern 281 and the placement rule 291 corresponding to each access pattern 281. As indicated in FIGS. 9 and 10, a detection rule for detecting the access pattern 281 and the placement rule 291 for the decoy file 191 are defined for each access pattern 281.

“Access pattern characteristic” is a distinctive feature of each access pattern 281.

“Detection rule” is a rule for detecting each access pattern 281 and is defined according to the “access pattern characteristic”.

“Future expected action” is a file access expected as a future action of the user or tool.

The placement rule 291 is a rule defined according to the “future expected action”.

The access pattern DB 280 does not need to store information indicating the “access pattern characteristic” and information indicating the “future expected action”.

The decoy placement unit 140 according to this embodiment places one or more decoy files 191 in the placement target area according to the placement rule 291 corresponding to the access pattern of a high-risk user in the target system 20. Specifically, the decoy placement unit 140 instructs the malicious insider countermeasure plug-in to place the decoy files 191 according to the placement policy indicated by the placement policy information 211. The decoy placement unit 140 also has a function to place the decoy file 191 not only in the vicinity of the placement non-target area but also in a wide range other than the vicinity of the placement non-target area according to the placement policy for the decoy file 191 corresponding to the access pattern 281 corresponding to a high-risk user.

### Description of Operation

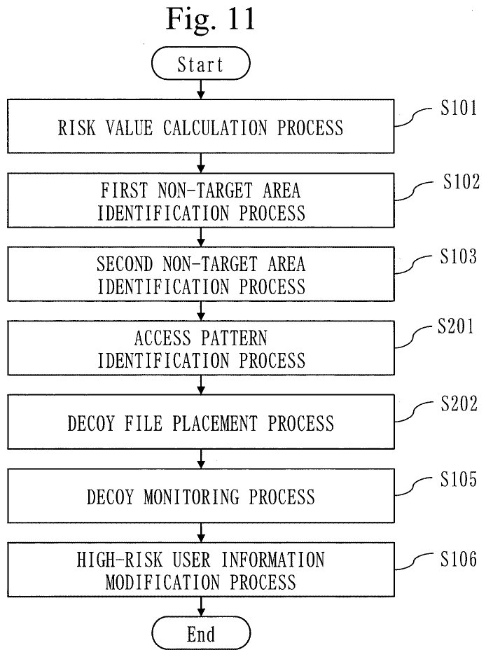

FIG. 11 is a flowchart illustrating an example of the operation of the placement location selection device 100. Using FIG. 11, the operation of the placement location selection device 100 will be described.

### (Step S201: Access Pattern Identification Process)

The access pattern analysis unit 210 identifies the access pattern 281 of a high-risk user based on the access pattern DB 280 and the access log of the high-risk user indicated by the access log DB 180, identifies the placement rule 291 corresponding to the identified access pattern 281 from the placement rule DB 290, and generates placement policy information 211 based on the identified placement rule 291.

### (Step S202: Decoy File Placement Process)

The decoy placement unit 140 selects a decoy file 191 from the decoy file DB 190, and places the selected decoy file 191 at a location avoiding the first non-target area and the second non-target area according to the placement policy information 211 generated in step S201.

### Description of Effects of Embodiment 2

As described above, according to this embodiment, the decoy file 191 is placed according to the access pattern 281 of a high-risk user, so that the decoy file 191 can be placed more effectively depending on the type of fraudulent file access.

### Other Embodiments

The embodiments described above may be freely combined, or any constituent element of each embodiment may be modified, or any constituent element may be omitted in each embodiment.

The embodiments are not limited to those described in Embodiments 1 and 2, and various modifications are possible as necessary. The procedures described using flowcharts or the like may be modified as appropriate.

### REFERENCE SIGNS LIST

11: processor; 12: storage device; 18: processing circuit; 20: target system; 21: access log; 90: placement location selection system; 100: placement location selection device; 110: log collection unit; 120: risk value calculation unit; 121: high-risk user information; 130: normal work analysis unit; 131: non-target area information; 140: decoy placement unit; 141: decoy file information; 150: decoy monitoring unit; 151: decoy file access information; 180: access log DB; 190: decoy file DB; 191: decoy file; 210: access pattern analysis unit; 211: placement policy information; 280: access pattern DB; 281: access pattern; 290: placement rule DB; 291: placement rule.

1. A placement location selection device comprising
processing circuitry to:
place one or more decoy files in a placement target area corresponding to part of a file tree and excluding a first non-target area and a second non-target area,
the first non-target area being an area corresponding to part of the file tree managed by a target system and including one or more files estimated to be used by a high-risk user who is a user of the target system in normal work of the high-risk user among files included in a target file group composed of files accessed by the high-risk user and indicated by an access log in the target system,
the second non-target area being an area corresponding to part of the file tree and including one or more files estimated to be accessed by each user included in a target normal user group in normal work of each user, the target normal user group being composed of one or more users, other than the high-risk user, of the target system who have accessed at least one file that is present outside the first non-target area among the files included in the target file group; and
estimate each of the first non-target area and the second non-target area based on an access log in the target system.

2. The placement location selection device according to claim 1,
wherein the placement target area includes an area expected to be accessed by the high-risk user.

3. The placement location selection device according to claim 1,
wherein the processing circuitry calculates a risk value corresponding to each user of the target system based on an access pattern in the target system of each user, and
wherein the high-risk user is a user whose corresponding risk value is equal to or greater than a risk reference value among users of the target system.

4. The placement location selection device according to claim 3,
wherein when a target user who is a user of the target system has accessed at least one of the one or more decoy files, the processing circuitry raises a risk value corresponding to the target user.

5. A placement location selection device comprising
processing circuitry to:
place one or more decoy files in a placement target area corresponding to part of a file tree and excluding a first non-target area and a second non-target area,
the first non-target area being an area corresponding to part of the file tree managed by a target system and including one or more files estimated to be used by a high-risk user who is a user of the target system in normal work of the high-risk user among files included in a target file group composed of files accessed by the high-risk user and indicated by an access log in the target system,
the second non-target area being an area corresponding to part of the file tree and including one or more files estimated to be accessed by each user included in a target normal user group in normal work of each user, the target normal user group being composed of one or more users, other than the high-risk user, of the target system who have accessed at least one file that is present outside the first non-target area among the files included in the target file group,
wherein the processing circuitry places the one or more decoy files in the placement target area according to a placement rule corresponding to an access pattern of the high-risk user in the target system.

6. The placement location selection device according to claim 5,
wherein the placement target area includes an area expected to be accessed by the high-risk user.

7. The placement location selection device according to claim 5,
wherein the processing circuitry calculates a risk value corresponding to each user of the target system based on an access pattern in the target system of each user, and
wherein the high-risk user is a user whose corresponding risk value is equal to or greater than a risk reference value among users of the target system.

8. The placement location selection device according to claim 7,
wherein when a target user who is a user of the target system has accessed at least one of the one or more decoy files, the processing circuitry raises a risk value corresponding to the target user.

9. The placement location selection device according to claim 5,
wherein the processing circuitry estimates each of the first non-target area and the second non-target area based on an access log in the target system.

10. The placement location selection device according to claim 5,
wherein a placement rule corresponding to an access pattern corresponding to a case where the high-risk user uses malware is a rule that the one or more decoy files are to be placed in an area that is at least a reference distance away in the file tree from a file accessed by the high-risk user within a past reference time period from a time point of placement of the one or more decoy files.

11. The placement location selection device according to claim 5,
wherein the processing circuitry analyzes an access pattern in the target system of each user of the target system based on an access log in the target system.

12. The placement location selection device according to claim 10,
wherein the processing circuitry analyzes an access pattern in the target system of each user of the target system based on an access log in the target system.

13. A placement location selection method comprising:
placing one or more decoy files in a placement target area corresponding to part of a file tree and excluding a first non-target area and a second non-target area, by a computer,
the first non-target area being an area corresponding to part of the file tree managed by a target system and including one or more files estimated to be used by a high-risk user who is a user of the target system in normal work of the high-risk user among files included in a target file group composed of files accessed by the high-risk user and indicated by an access log in the target system,
the second non-target area being an area corresponding to part of the file tree and including one or more files estimated to be accessed by each user included in a target normal user group in normal work of each user, the target normal user group being composed of one or more users, other than the high-risk user, of the target system who have accessed at least one file that is present outside the first non-target area among the files included in the target file group; and
estimating each of the first non-target area and the second non-target area based on an access log in the target system, by the computer.

14. A placement location selection method comprising:
placing one or more decoy files in a placement target area corresponding to part of a file tree and excluding a first non-target area and a second non-target area, by a computer,
the first non-target area being an area corresponding to part of the file tree managed by a target system and including one or more files estimated to be used by a high-risk user who is a user of the target system in normal work of the high-risk user among files included in a target file group composed of files accessed by the high-risk user and indicated by an access log in the target system,
the second non-target area being an area corresponding to part of the file tree and including one or more files estimated to be accessed by each user included in a target normal user group in normal work of each user, the target normal user group being composed of one or more users, other than the high-risk user, of the target system who have accessed at least one file that is present outside the first non-target area among the files included in the target file group; and
placing the one or more decoy files in the placement target area according to a placement rule corresponding to an access pattern of the high-risk user in the target system, by the computer.

15. A non-transitory computer readable medium storing a placement location selection program that causes a placement location selection device, which is a computer, to execute:
a decoy placement process of placing one or more decoy files in a placement target area corresponding to part of a file tree and excluding a first non-target area and a second non-target area,
the first non-target area being an area corresponding to part of the file tree managed by a target system and including one or more files estimated to be used by a high-risk user who is a user of the target system in normal work of the high-risk user among files included in a target file group composed of files accessed by the high-risk user and indicated by an access log in the target system,
the second non-target area being an area corresponding to part of the file tree and including one or more files estimated to be accessed by each user included in a target normal user group in normal work of each user, the target normal user group being composed of one or more users, other than the high-risk user, of the target system who have accessed at least one file that is present outside the first non-target area among the files included in the target file group; and
a normal work analysis process of estimating each of the first non-target area and the second non-target area based on an access log in the target system.

16. A non-transitory computer readable medium storing a placement location selection program that causes a placement location selection device, which is a computer, to execute
a decoy placement process of placing one or more decoy files in a placement target area corresponding to part of a file tree and excluding a first non-target area and a second non-target area,
the first non-target area being an area corresponding to part of the file tree managed by a target system and including one or more files estimated to be used by a high-risk user who is a user of the target system in normal work of the high-risk user among files included in a target file group composed of files accessed by the high-risk user and indicated by an access log in the target system,
the second non-target area being an area corresponding to part of the file tree and including one or more files estimated to be accessed by each user included in a target normal user group in normal work of each user, the target normal user group being composed of one or more users, other than the high-risk user, of the target system who have accessed at least one file that is present outside the first non-target area among the files included in the target file group,
wherein in the decoy placement process, the one or more decoy files are placed in the placement target area according to a placement rule corresponding to an access pattern of the high-risk user in the target system.
